(19) United States
(12) Patent Application Publication
(10) Pub. No.: US 2022/0299896 A1
(43) Pub. Date: Sep. 22, 2022

(54) PREPARING METHOD OF ELECTROSTATIC CHARGE IMAGE DEVELOPING TONER, ELECTROSTATIC CHARGE IMAGE DEVELOPING TONER, AND ELECTROSTATIC CHARGE IMAGE DEVELOPER

(71) Applicant: FUJIFILM Business Innovation Corp., Tokyo (JP)

(72) Inventors: Takahiro YAMASHITA, Kanagawa (JP); Yoshimasa Fujihara, Kanagawa (JP); Daisuke Noguchi, Kanagawa (JP); Hiroshi Nakazawa, Kanagawa (JP); Yuji Isshiki, Kanagawa (JP)

(73) Assignee: FUJIFILM Business Innovation Corp., Tokyo (JP)

(21) Appl. No.: 17/404,127

(22) Filed: Aug. 17, 2021

(30) Foreign Application Priority Data
Mar. 22, 2021 (JP) 2021-047974

(51) Int. Cl. G03G 9/08

(52) U.S. Cl. CPC G03G 9/0804

(57) ABSTRACT

A preparing method of an electrostatic charge image developing toner includes: aggregating binder resin particles in a dispersion containing the binder resin particles to form aggregated particles; and coalescing the aggregated particles by heating a dispersion containing the aggregated particles to form toner particles, in which the coalescing includes heating the dispersion containing the aggregated particles to 80° C. or higher so that a temperature of the dispersion containing the aggregated particles reaches 80° C., and then adding an acid and a surfactant to the dispersion containing the aggregated particles.

### CROSS-REFERENCE TO RELATED APPLICATIONS

This application is based on and claims priority under 35 USC 119 from Japanese Patent Application No. 2021-047974 filed on Mar. 22, 2021.

### BACKGROUND

### (i) Technical Field

The present disclosure relates to a preparing method of an electrostatic charge image developing toner, an electrostatic charge image developing toner, and electrostatic charge image developer.

### (ii) Related Art

JP2000-131882A discloses a preparing method of an electrostatic charge image developing toner in which an aggregating agent and a stabilizer are added to an aqueous dispersion containing at least polymer fine particles and coloring agent fine particles to associate a large number of fine particles, associated particles are heat-coalesced at a temperature that is a glass transition temperature of the polymer fine particles or higher, and a concentration of at least one of the aggregating agent or the stabilizer during heat coalescence.

JP2008-304874A discloses a preparing method of an electrostatic charge image developing toner including, at least: an aggregating step of aggregating particles while stirring a dispersion containing polymer primary particles and coloring agent particles to obtain a particle aggregate; and an aging step of coalescing the particle aggregate at a temperature higher than a glass transition temperature of the polymer primary particles, in which in the aging step, the temperature is raised while adding a dispersant.

### SUMMARY

Aspects of non-limiting embodiments of the present disclosure relate to a preparing method of an electrostatic charge image developing toner in which mixing of a coarse toner is reduced compared to a case of adding an acid and a surfactant before a temperature of a dispersion containing aggregated particles reaches 80° C. in a coalescing step.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a preparing method of an electrostatic charge image developing toner, the method including: aggregating binder resin particles in a dispersion containing the binder resin particles to form aggregated particles; and coalescing the aggregated particles by heating a dispersion containing the aggregated particles to form toner particles, in which the coalescing includes heating the dispersion containing the aggregated particles to 80° C. or higher so that a temperature of the dispersion containing the aggregated particles reaches 80° C., and then adding an acid and a surfactant to the dispersion containing the aggregated particles.

### DETAILED DESCRIPTION

Hereinafter, exemplary embodiments of the present disclosure will be described. These descriptions and examples illustrate exemplary embodiments and do not limit the scope of the exemplary embodiments.

The numerical range indicated by using “to” in the present disclosure indicates a range including the numerical values before and after “to” as the minimum value and the maximum value, respectively.

In a numerical range described in steps in the present disclosure, an upper limit or a lower limit described in one numerical range may be replaced with an upper limit or a lower limit of another numerical range described in steps. Further, in the numerical range described in the present disclosure, the upper limit or the lower limit on the numerical range may be replaced with the value described in examples.

In the present disclosure, the term “step” includes not only an independent step but also other steps as long as the intended purpose of the step is achieved even if it is not able to be clearly distinguished from other steps.

In the present disclosure, each component may contain plural kinds of applicable substances. When referring to the amount of each component in a composition in the present disclosure, in a case where there are plural kinds of substances corresponding to each component in the composition, the amount of each component in the composition means a total amount of the plural kinds of substances present in the composition, unless otherwise specified.

In the present disclosure, plural kinds of particles corresponding to each component may be contained. In a case where there are plural kinds of particles corresponding to each component in a composition, a particle diameter of each component means a value in a mixture of the plural kinds of particles present in the composition, unless otherwise specified.

In the present disclosure, “(meth)acrylic” means at least one of acrylic or methacrylic, and “(meth)acrylate” means at least one of acrylate or methacrylate.

In the present disclosure, a “toner” refers to an “electrostatic charge image developing toner”, a “developer” refers to an “electrostatic charge image developer”, and a “carrier” refers to a “electrostatic charge image carrier”.

In the present disclosure, a method for preparing a toner particle by aggregating and coalescing material particles in a solvent is referred to as an emulsion aggregation (EA) method.

### <Preparing Method of Electrostatic Charge Image Developing Toner>

The preparing method of a toner according to the exemplary embodiment is a preparing method of a toner including preparing toner particles by the EA method, and has the following aggregating step and coalescing step.

Aggregating step: A step of aggregating binder resin particles in a dispersion containing the binder resin particles to form aggregated particles.

Coalescing step: A step of coalescing the aggregated particles by heating a dispersion containing the aggregated particles to form toner particles.

In the preparing method of a toner according to the exemplary embodiment, the coalescing step includes heating the dispersion containing the aggregated particles to 80° C. or higher so that a temperature of the dispersion containing the aggregated particles reaches 80° C., and then adding an acid and a surfactant to the dispersion containing the aggregated particles.

As an example of causes of mixing of the coarse toner, the aggregated particles are aggregated and coalesced when coalescing each aggregated particle.

Hereinafter, steps and materials of the preparing method of a toner according to the exemplary embodiment will be described in detail.

### [Aggregating Step (First Aggregating Step)]

Aggregating step is a step of aggregating at least binder resin particles in a dispersion containing at least the binder resin particles to form aggregated particles.

The dispersion to be used in the aggregating step may also contain at least one of the release agent particles or the coloring agent particles. Therefore, the aggregating step may be a step of aggregating at least one of the release agent particles or the coloring agent particles together with the binder resin particles.

In a case where the preparing method of a toner according to the exemplary embodiment includes a second aggregating step (step of forming a shell layer) to be described later, the above aggregating step is referred to as a “first aggregating step”. The first aggregating step is a step of forming a core in a toner having a core-shell structure.

For example, a resin particle dispersion containing binder resin particles, a release agent particle dispersion containing release agent particles, and a coloring agent particle dispersion containing coloring agent particles are prepared respectively, and these particle dispersions are mixed to prepare the dispersion to be used in the aggregating step. The order of mixing these particle dispersions is not limited.

Hereinafter, what is common to the resin particle dispersion, the release agent particle dispersion, and the coloring agent particle dispersion will be collectively referred to as a “particle dispersion”.

An example of the exemplary embodiment of the particle dispersion is a dispersion in which a material is dispersed in a dispersion medium in the form of particles by a surfactant.

The dispersion medium of the particle dispersion may be an aqueous medium. Examples of the aqueous medium include water and alcohol. The water is preferably water having a reduced ion content such as distilled water and ion exchanged water. These aqueous media may be used alone, or two or more thereof may be used in combination.

The surfactant that disperses the material in a dispersion medium may be any of an anionic surfactant, a cationic surfactant, and a nonionic surfactant. Examples thereof include: anionic surfactants such as sulfate ester salt, sulfonate, phosphoric acid ester, and soap anionic surfactants; cationic surfactants such as amine salt and quaternary ammonium salt cationic surfactants; nonionic surfactants such as polyethylene glycol, alkyl phenol ethylene oxide adduct, and polyhydric alcohol nonionic surfactants; and the like. The surfactants may be used alone, or two or more thereof may be used in combination. Nonionic surfactants may be used in combination with anionic surfactants or cationic surfactants.

Examples of a method of dispersing the material in the dispersion medium in the form of particles include a common dispersing method using a rotary shearing-type homogenizer, or a ball mill, a sand mill, or a Dyno mill as media.

Examples of the method of dispersing the resin in the dispersion medium in the form of particles include a phase inversion emulsification method. The phase inversion emulsification method includes: dissolving a resin in a hydrophobic organic solvent in which the resin is soluble; conducting neutralization by adding a base to an organic continuous phase (O phase); and performing phase inversion from W/O to O/W by adding an aqueous medium (W phase), thereby dispersing the resin as particles in the aqueous medium.

A volume average particle diameter of the particles dispersed in the particle dispersion may be 30 nm or more and 300 nm or less, preferably 50 nm or more and 250 nm or less, and more preferably 80 nm or more and 200 nm or less.

The volume average particle diameter of the particles in the particle dispersion refers to a particle diameter when the cumulative percentage becomes 50% from the small diameter side in a particle size distribution measured by a laser diffraction-type particle size distribution measuring device (for example, manufactured by Horiba, Ltd., LA-700).

The content of the particles contained in the particle dispersion may be, for example, 5% by weight or more and 50% by weight or less, preferably 10% by weight or more and 40% by weight or less, and more preferably 15% by weight or more and 30% by weight or less.

### -Binder Resin-

Examples of the binder resin include a homopolymer of monomer such as styrenes (for example, styrene, parachlorostyrene, and u-methylstyrene), (meth)acrylates (for example, methyl acrylate, ethyl acrylate, n-propyl acrylate, n-butyl acrylate, lauryl acrylate, 2-ethyl hexyl acrylate, methyl methacrylate, ethyl methacrylate, n-propyl methacrylate, lauryl methacrylate, and 2-ethyl hexyl methacrylate), ethylenically unsaturated nitriles (for example, acrylonitrile and methacrylonitrile), vinyl ethers (for example, vinyl methyl ether, and vinyl isobutyl ether), vinyl ketones (for example, vinyl methyl ketone, vinyl ethyl ketone, and vinyl isopropenyl ketone), olefins (for example, ethylene, propylene, and butadiene), or a vinyl-based resin composed of a copolymer obtained by combining two or more of these monomers.

Examples of the binder resin also include a non-vinyl resin such as an epoxy resin, a polyester resin, a polyurethane resin, a polyarnide resin, a cellulose resin, a polyether resin, and a modified rosin, a mixture of these resins and the vinyl-based resin, or a graft polymer obtained by polymerizing a vinyl monomer in the coexistence.

These binder resins may be used alone, or two or more thereof may be used in combination.

The binder resin may be a polyester resin. Examples of the polyester resin include known polyester resins.

Examples of the polyester resin include a condensation polymer of polyvalent carboxylic acid and polyhydric alcohol. Note that, as the polyester resin, a commercially available product may be used, or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenylsuccinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, or lower (for example, 1 or more and 5 or less carbon atoms) alkyl esters thereof. Among these, as the polyvalent carboxylic acid, for example, aromatic dicarboxylic acid is preferable.

As the polyvalent carboxylic acid, trivalent or higher carboxylic acid having a crosslinked structure or a branched structure may be used in combination with dicarboxylic acid. Examples of the trivalent or higher carboxylic acid include trimellitic acid, pyromellitic acid, anhydrides thereof, and lower (for example, 1 or more and 5 or less carbon atoms) alkyl esters thereof.

These polyvalent carboxylic acids may be used alone, or two or more thereof may be used in combination.

Examples of polyhydric alcohols include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, a bisphenol A ethylene oxide adduct and a bisphenol A propylene oxide adduct). Among these, as the polyhydric alcohol, for example, aromatic diols and alicyclic diols are preferable, and aromatic diols are more preferable.

As the polyhydric alcohol, tri- or higher polyhydric alcohol having a crosslinked. structure or a branched structure may be used together with the diol. Examples of the tri- or higher polyhydric alcohol include glycerin, trimethylolpropane, and pentaerythritol.

These polyhydric alcohols may be used alone, or two or more thereof may be used in combination.

A glass transition temperature (Tg) of a polyester resin may be 50° C. or higher and 80° C. or lower, and preferably 50° C. or higher and 65° C. or lower.

The glass transition temperature is obtained from a DSC curve obtained by differential scanning calorimetry (DSC), More specifically, the glass transition temperature is obtained from “extrapolated glass transition onset temperature” described in the method of obtaining a glass transition temperature in JIS K 7121-1987 “testing methods for transition temperatures of plastics”.

A weight average molecular weight (Mw) of the polyester resin may be 5,000 or more and 1,000,000 or less, and preferably 7,000 or more and 500,000 or less.

The number average molecular weight (Mn) of the polyester resin may be 2,000 or more and 100,000 or less.

The molecular weight distribution Mw/Mn of the polyester resin may be 1.5 or more and 100 or less, and is preferably 2 or more and 60 or less.

The weight average molecular weight and the number average molecular weight are measured by gel permeation chromatography (GPC). The molecular weight measurement by GPC is performed using GPC-HLC-8120 GPC, manufactured by Tosoh Corporation as a measuring device, Colum·TSK gel Super HM-M (15 cm), manufactured by Tosoh Corporation, and a THF solvent. The weight average molecular weight and the number average molecular weight are calculated by using a molecular weight calibration curve plotted from a monodisperse polystyrene standard sample from the results of the foregoing measurement.

A known preparing method is used to prepare the polyester resin. Specific examples thereof include a method of conducting a reaction at a polymerization temperature set to be 180° C. of higher and 230° C. or lower, if necessary, under reduced pressure in the reaction system, while removing water or an alcohol generated during condensation.

When monomers of the raw materials are not dissolved or compatibilized under a reaction temperature, a high-boiling-point solvent may be added as a solubilizing agent to dissolve the monomers. In this case, a polycondensation reaction is conducted while distilling away the solubilizing agent. When a monomer having poor compatibility is present in a copolymerization reaction, the monomer having poor compatibility and an acid or an alcohol to be polycondensed with the monomer may be previously condensed and then polycondensed with the major component.

### -Release Agent-

Examples of the release agent include hydrocarbon waxes; natural waxes such as carnauba wax, rice wax, and candelilla wax synthetic or mineral/petroleum waxes such as montan wax; and ester waxes such as fatty acid esters and montanic acid esters. The release agent is not limited to the examples.

The melting temperature of the release agent may be 50° C. or higher and 110° C. or lower, and preferably 60° C. or higher and 100° C. or lower.

The melting temperature of the release agent is obtained from a DSC curve obtained by differential scanning calorimetry (DSC), and specifically obtained in accordance with “melting peak temperature” described in the method of obtaining a melting temperature in JIS K 7121: 1987 “testing methods for transition temperatures of plastics”.

### -Coloring Agent-

Examples of the coloring agent includes various types of pigments such as carbon black, chrome yellow, Hansa yellow, benzidine yellow, threne yellow; quinoline yellow, pigment yellow Permanent Orange GTR, Orange, Vulcan Orange, Watch Young Red, Permanent Red, Brilliant Carmine 3B, Brilliant Carmine 6B, DuPont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate, or various types of dyes such as acridine dye, xanthene dye, azo dye, benzoquinone dye, azine dye, anthraquinone dye, thioindigo dye, dioxazine dye, thiazine dye, azomethine dye, indigo dye, phthalocyanine dye, aniline black dye, polymethine dye, triphenylmethane dye, diphenylmethane dye, and thiazole dye. These coloring agents may be used alone, or two or more thereof may be used in combination.

As the coloring agent, if necessary, a surface-treated coloring agent may be used, or a dispersant may be used in combination.

A dispersion obtained by mixing plural kinds of particle dispersions is called a “mixed dispersion”.

It is favorable to adjust a pH of the mixed dispersion to 3 or higher and 4 or lower after mixing the plural kinds of particle dispersions. Examples of a method of adjusting the pH of the mixed dispersion include adding an acidic aqueous solution of nitric acid, hydrochloric acid, or sulfuric acid.

A weight ratio of the particles contained in the mixed dispersion may be in the following range.

In a case where the mixed dispersion contains the release agent particles, the weight ratio between the binder resin particles and the release agent particles may be binder resin particles:release agent particles 100:1 to 100:40, preferably 100:2 to 100:30, and more preferably 100:5 to 100:20.

In a case where the mixed dispersion contains the coloring agent particles, the weight ratio between the binder resin particles and the coloring agent particles may be binder resin particles:coloring agent particles=100:1 to 100:100, preferably 100:2 to 100:40, and more preferably 100:5 to 100:20.

The aggregating step includes adding an aggregating agent to the mixed dispersion while stirring the mixed dispersion, and heating the mixed dispersion while stirring the mixed dispersion after adding the aggregating agent to the mixed dispersion to raise the temperature of the mixed dispersion.

Examples of the aggregating agent include a surfactant having an opposite polarity to the polarity of the surfactant contained in the mixed dispersion, an inorganic metal salt, a divalent or more metal complex. These aggregating agents may be used alone, or two or more thereof may be used in combination.

Examples of the inorganic metal salt include: metal salt such as calcium chloride, calcium nitrate, barium chloride, magnesium chloride, zinc chloride, aluminum chloride, and aluminum sulfate; an inorganic metal salt polymer such as poly aluminum chloride, poly aluminum hydroxide, and calcium polysulfide; and the like.

The aggregating agent may be a divalent or higher valent metal salt compound, and a trivalent metal salt compound is preferable, and a trivalent inorganic aluminum salt compound is more preferable. Examples of the trivalent inorganic aluminum salt compound include aluminum chloride, aluminum sulfate, polyaluminum chloride, and polyaluminum hydroxide,

The additive amount of the aggregating agent is not limited. In a case where the trivalent metal salt compound is used as the aggregating agent, the additive amount of the trivalent metal salt compound may be 0.01 parts by weight or more and 10 parts by weight or less, preferably 0.05 parts by weight or more and 5 parts by weight or less, and more preferably 0.1 parts by weight or more and 3 parts by weight or less, with respect to 100 parts by weight of the binder resin.

A temperature of the mixed dispersion reached when heating the mixed dispersion may be a temperature based on the glass transition temperature (Tg) of the binder resin particles, for example, (Tg-30° C.) or higher of the binder resin particles and (Tg° C.) or lower.

In a case where the mixed dispersion contains plural kinds of binder resin particles having different Tg, the lowest temperature of each Tg is used as the Tg in the aggregating step.

### [Second Aggregating Step]

The second aggregating step is a step provided for the purpose of preparing a toner having a core-shell structure, and is a step provided after the first aggregating step. The second aggregating step is a step of forming a shell layer.

The second aggregating step is a step of further mixing a dispersion containing the aggregated particles and a dispersion containing resin particles to be a shell layer and aggregating the resin particles to be a shell layer on surfaces of the aggregated particles to form second aggregated particles.

The dispersion containing the resin particles to he the shell layer may be at least one selected from the binder resin particle dispersion for forming the core, and the polyester resin particle dispersion is preferable.

The second aggregating step includes, for example, adding a dispersion containing the resin particles to be the shell layer to a dispersion containing the aggregated particles while stirring the dispersion containing the aggregated particles, and heating the dispersion containing the aggregated particles after adding the dispersion containing the resin particles to be the shell layer while stirring the dispersion.

A temperature of the dispersion containing the aggregated particles reached when heating the dispersion containing the aggregated particles may be a temperature based on the glass transition temperature (Tg) of the resin particles to be the shell layer, for example, (Tg-30° C.) or higher of the resin particles to be the shell layer and (Tg-10° C.) or lower.

After the aggregated particles or the second aggregated particles are grown to a predetermined size and before heating of the coalescing step, a chelating agent relative to the aggregating agent used in the aggregating step may be added to the dispersion containing the aggregated particles and the second aggregated particles, for the purpose of stopping the growth of the aggregated particles and the second aggregated particles.

Examples of the chelating agent include: oxycarboxylic acid such as tartaric acid, citric acid, and gluconic acid; aminocarboxylic acid such as iminodiacetic acid (IDA), nitrilotriacetic acid (NTA), and ethylenediaminetetraacetic acid (EDTA); and the like.

The additive amount of the chelating agent may be, for example, 0.01 parts by weight or more and 5.0 parts by weight or less, and preferably 0.1 parts by weight or more and less than 3.0 parts by weight, with respect to 100 parts by weight of the binder resin particles.

After the aggregated particles or the second aggregated particles are grown to a predetermined size and before heating of the coalescing step, the pH of the dispersion containing the aggregated particles and the second aggregated particles may be raised, for the purpose of stopping the growth of the aggregated particles and the second aggregated particles.

Examples of a method of raising the pH of the dispersion containing the aggregated particles or the second aggregated particles include adding at least one selected from the group consisting of an aqueous solution of alkali metal hydroxide and aqueous solution of alkaline earth metal hydroxide.

A reached pH of the dispersion containing the aggregated particles or the second aggregated particles may be 8 or more and 10 or less.

### [Coalescing Step]

The coalescing step is a step of coalescing the aggregated particles by heating a dispersion containing the aggregated particles to form toner particles. Therefore, in the coalescing step, heating the dispersion containing the aggregated particles to 80° C. or higher so that a temperature of the dispersion containing the aggregated particles reaches 80° C., and then adding an acid and a surfactant to the dispersion containing the aggregated particles are performed.

In a case where the second aggregating step is provided before the coalescing step, the coalescing step is a step of coalescing the second aggregated particles by heating the dispersion containing the second aggregated particles to form toner particles. Therefore, in the coalescing step, heating the dispersion containing the second aggregated particles to 80° C. or higher so that a temperature of the dispersion containing the second aggregated particles reaches 80° C., and then adding an acid and a surfactant to the dispersion containing the second aggregated particles are performed.

The toner particles having a core-shell structure may be prepared by going through the second aggregating step and the coalescing step.

The exemplary embodiment to be described below is common to the aggregated particles and the second aggregated particles.

In the coalescing step, the dispersion containing the aggregated particles is heated to 80° C. or higher. A reached temperature of the dispersion containing the aggregated particles may be (glass transition temperature of binder resin particles+50° C.) or lower.

Therefore, the temperature of the dispersion containing the aggregated particles when adding the acid and the surfactant may be 80° C. or higher and (glass transition temperature of binder resin particles+50° C.) or lower.

In a case where the aggregated particles contain plural kinds of binder resin having different glass transition temperature, the maximum temperature of each glass transition temperature is used as the glass transition temperature in the coalescing step.

It is preferable to add the acid and the surfactant to the dispersion containing the aggregated particles at the maximum temperature at which the temperature of the dispersion containing the aggregated particles reaches.

It is preferable that adding the acid and the surfactant to the dispersion containing the aggregated particles is started at a time when 10 minutes or more and 3 hours or less passes from a time when the temperature of the dispersion containing the aggregated particles reaches a maximum temperature.

Adding the acid and the surfactant within 3 hours from the time when the maximum temperature is reached prevents the aggregated particles from being aggregated and coalesced with each other, and prevents coarse particles from being generated. From the viewpoint, it is more preferable to add the acid and the surfactant within 2 hours from the time when the maximum temperature is reached, and it is still further preferable to add the acid and the surfactant within 1 hour from the time when the maximum temperature is reached.

A surface texture (for example, circularity) of the toner particles is improved by allowing 10 minutes or more to pass from the time when the maximum temperature is reached to the start of addition of the acid and the surfactant. From the viewpoint, it is more preferable to allow 20 minutes or more to pass from the time when the maximum temperature is reached to the start of addition of the acid and the surfactant, and it is more preferable to allow 30 minutes or more to pass from the time when the maximum temperature is reached to the start of addition of the acid and the surfactant.

An average circularity of the aggregated particles when adding the acid and the surfactant to the dispersion containing the aggregated particles may be 0.90 or more and 0.97 or less, preferably 0.91 or more and 0.96 or less, and more preferably 0.92 or more and 0.95 or less, from the viewpoint of the surface texture of the finished toner particles and the performance of the toner.

The average circularity of the particles in the dispersion is (Perimeter of a circle with the same area as a particle projection image)/(Perimeter of the particle projection image). The average circularity of the toner is determined by sampling 3,500 particles with a flow-type particle image analyzer (FPIA-3000 manufactured by SYSMEX CORPORATION).

Examples of the acid include nitric acid, sulfuric acid, hydrochloric acid, acetic acid, phosphoric acid, oxalic acid, malonic acid, succinic acid, glutaric acid, adipic acid, pimelic acid, suberic acid, azelaic acid, sebacic acid, maleic acid, fumaric acid, phthalic acid, isophthalic acid, terephthalic acid, citric acid, malic acid, trimellitic acid, acrylic acid, methacrylic acid, maleic acid, and cinnamic acid. These acids may be used alone, or two or more thereof may be used in combination. Among these, at least one selected from the group consisting of the nitric acid, the sulfuric acid, the hydrochloric acid, and the acetic acid is preferable.

The surfactant may be any of an anionic surfactant, a cationic surfactant, and a nonionic surfactant. Examples thereof include: anionic surfactants such as sulfate ester salt, sulfonate, phosphoric acid ester, and soap anionic surfactants; cationic surfactants such as amine salt and quaternary ammonium salt cationic surfactants; nonionic surfactants such as polyethylene glycol, alkyl phenol ethylene oxide adduct, and polyhydric alcohol nonionic surfactants; and the like. The surfactants may be used alone, or two or more thereof may be used in combination. Nonionic surfactants may be used in combination with anionic surfactants or cationic surfactants.

The surfactant to be used in the coalescing step may be an anionic surfactant. Specific examples of anionic surfactants include potassium laurate, sodium oleate, castor oil sodium, octyl sulfate, lauryl sulfate, lauryl ether sulfate, nonylphenyl ether sulfate, lauryl sulfonate, dodecylbenzene sulfonate, triisopropyl naphthalene sulfonate, dibutylnaphthalene sulfonate, sodium alkylbenzene sulfonate, naphthalene sulfonate formalin condensate, monooctyl sulfosuccinate, dioctyl sulfosuccinate, lauric acid amide sulfonate, oleic acid amide sulfonate, lauryl phosphate, isopropyl phosphate, nonylphenyl ether phosphate, sodium dioctyl sulfosuccinate, and disodium lauryl sulfosuccinate.

The combination of a kind of the acids and a kind of the surfactants is not limited, and the combination of the nitric acid and the anionic surfactant is preferable from the viewpoint of easily preventing the aggregated particles from being aggregated each other.

A ratio A/B of a molar amount A of the acid to a molar amount B of the surfactant to be added to the dispersion containing the aggregated particles may be 0.5 or more and 2.0 or less, preferably 0.7 or more and 1.8 or less, and more preferably 0.8 or more and 1.5 or less, from the viewpoint of easily preventing the aggregated particles from being aggregated each other.

A method of addition when adding the acid and the surfactant to the dispersion containing the aggregated particles is not limited. The acid and the surfactant may be added separately, simultaneously, or sequentially to the dispersion containing the aggregated particles.

From the viewpoint of easily preventing the aggregated particles from being aggregated each other, it is preferable to add a mixture in which the acid and the surfactant are mixed in advance to the dispersion containing the aggregated particles.

The mixture of the acid and the surfactant is, for example, an aqueous solution or an aqueous dispersion using water as a solvent or a dispersion medium. A total weight of the acid and the surfactant in a total weight of the mixture (for example, the aqueous solution or the aqueous dispersion) may be 1% by weight or more and 10% by weight or less, preferably 2% by weight or more and 8% by weight or less, and may be preferably 3% by weight or more and 6% by weight or less, from the viewpoints of an efficiency of exerting an effect and stability of an active ingredient in the mixture.

After completion of the coalescing step, dried toner particles are obtained by subjecting the toner particles in the dispersion to known cleaning step, a solid-liquid separation step, and drying step. In the cleaning step, displacement cleaning using ion exchanged water may be sufficiently performed from the viewpoint of charging properties. For the solid-liquid separation step, suction filtration, pressure filtration, or the like is preferably performed from the viewpoint of productivity. For the drying step, freeze drying, airflow drying, fluidized drying, vibration-type fluidized drying, or the like may be performed from the viewpoint of productivity.

### [Step of Externally Adding External Additive]

The preparing method of a toner according to the exemplary embodiment favorably includes a step of externally adding an external additive to the toner particles.

The external addition of the external additive to the toner particles is performed by mixing the dry toner particles and the external additive, The mixing may be performed with, for example, a V-blender, a Henschel mixer, a Lodige mixer, or the like. Furthermore, if necessary, coarse particles of the toner may be removed by using a vibration classifier, a wind classifier, or the like.

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaOSiO₂, K₂O·(TiO₂)ₘ, Al₂O₃·2SiO₂, CaCO₃, MgCO₃, BaSO₄, MgSO₄, and the like.

The surface of the inorganic particles as the external additive may be treated with a hydrophobizing agent. The hydrophobic treatment is performed, for example, by immersing the inorganic particles in a hydrophobizing agent. The hydrophobizing agent is not particularly limited, and examples thereof include a silane coupling agent, a silicone oil, a titanate coupling agent, and an aluminum coupling agent. These may be used alone, or two or more thereof may be used in combination.

The amount of the hydrophobizing agent is usually, for example, 1 part by weight or more and 10 parts by weight or less with respect to 100 parts by weight of the inorganic particles.

Examples of the external additive also include a resin particle (resin particles such as polystyrene, polymethylmethacrylate, and melamine resin), a cleaning aid (for example, a metal salt of higher fatty acid typified by zinc stearate, and a particle of fluorine-based high molecular weight body), and the like.

The external addition amount of the external additives may be 0.01% by weight or more and 5% by weight or less and preferably 0.01% by weight or more and 2.0% by weight or less, with respect to the weight of the toner particles.

### <Toner>

The toner prepared by the preparing method according to the exemplary embodiment may be an external additive toner in which an external additive is externally added to the toner particles. The form of the external additive is as described above.

The toner prepared by the preparing method according to the exemplary embodiment may be a toner having a single-layer structure, or may be a toner having a core-shell structure including a core portion (core) and a coating layer (shell layer) coating the core portion. The toner having the core-shell structure has: for example, a core portion containing a binder resin, a release agent, and a coloring agent; and a coating layer containing a binder resin.

The content of the binder resin may be 40% by weight or more and 95% by weight or less, preferably 50% by weight or more and 90% by weight or less, and more preferably 60% by weight or more and 85% by weight or less, with respect to the entire toner particles.

The content of the release agent may be 1% by weight or more and 20% by weight or less, and preferably 5% by weight or more and 15% by weight or less with respect to the entire toner.

When the toner contains the coloring agent, the content of the coloring agent may be 1% by weight or more and 30% by weight or less, and preferably 3% by weight or more and 15% by weight or less, with respect to the entire toner.

The volume average particle diameter of the toner particles may be 2 μm or more and 10 μm or less and preferably 4 μm or more and 8 μm or less. A measuring method of the volume average particle diameter of the toner is as follows.

The particle size distribution of the toner is measured using Coulter Multisizer Type II (manufactured by Beckman Coulter, Inc.) and using ISOTON-II (manufactured by Beckman Coulter, Inc.) as the electrolytic solution. In the measurement, a measurement sample of 0.5 mg or more and 50 mg or less is added to 2 ml of 5% by weight aqueous solution of a surfactant (preferably sodium alkylbenzene sulfonate) as a dispersant. This is added to the electrolytic solution of 100 ml to 150 ml, The electrolytic solution in which the sample is suspended is dispersed for 1 minute by an ultrasonic dispersion. Then, using the Coulter Multisizer II type, the particle size distribution of the particles having a particle diameter of 2 μm or more and 60 μm or less is measured using an aperture having an aperture diameter of 100 μm. The number of particles to be sampled is 50,000. The particle size distribution is drawn from the small diameter side, and a particle diameter at a cumulative total of 50% is defined as the volume average particle diameter D50v.

The average circularity of the toner may be 0.94 or more and 1.00 or less, and preferably 0.95 or more and 0.98 or less.

The average circularity of the toner is (Perimeter of a circle with the same area as a particle projection image)/(Perimeter of the particle projection image). The average circularity of the toner is determined by sampling 3,500 particles with a flow-type particle image analyzer (FPIA-3000 manufactured by SYSMEX CORPORATION).

### <Developer>

The toner prepared by the preparing method according to the exemplary embodiment may be used as a single-component developer, or may be used as a two-component developer by mixing with a carrier.

The carrier is not particularly limited, and a well-known carrier may be used. Examples of the carrier include a coating carrier in which the surface of the core formed of magnetic particles is coated with the resin; a magnetic particle dispersion-type carrier in which the magnetic particles are dispersed and distributed in the matrix resin; and a resin impregnated-type carrier in which a resin is impregnated into the porous magnetic particles.

The magnetic particle dispersion-type carrier or the resin impregnated-type carrier may be a carrier in which the forming particle of the carrier is set as a core and the surface of the core is coated with the resin.

Examples of the magnetic particle include: a magnetic metal such as iron, nickel, and cobalt; a magnetic oxide such as ferrite, and magnetite; and the like.

Examples of the coating resin and the matrix resin include a straight silicone resin formed by containing polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid ester copolymer, and an organosiloxane bond, or the modified products thereof, a fluororesin, polyester, polycarbonate, a phenol resin, and an epoxy resin. Other additives such as the conductive particles may be contained in the coating resin and the matrix resin. Examples of the conductive particles include metal such as gold, silver, and copper, carbon black, titanium oxide, zinc oxide, tin oxide, barium sulfate, aluminum borate, and potassium titanate.

Here, in order to coat the surface of the core with the resin, a method of coating the surface with a coating layer forming solution in which the coating resin and various additives (to be used if necessary) are dissolved in a proper solvent is used. The solvent is not particularly limited as long as a solvent is selected in consideration of a kind of a resin to be used and coating suitability.

Specific examples of the resin coating method include: a dipping method of dipping the core into the coating layer forming solution; a spray method of spraying the coating layer forming solution onto the surface of the core; a fluid-bed method of spraying the coating layer forming solution to the core in a state of being floated by the fluid air; a kneader coating method of mixing the core of the carrier with the coating layer forming solution and removing a solvent in the kneader coater; and the like.

The mixing ratio (weight ratio) of the toner to the carrier in the two-component developer may be in a range of toner: carrier=1:100 to 30:100, and is preferably in a range of 3:100 to 20:100.

### EXAMPLES

Hereinafter, exemplary embodiments of the disclosure will be described in detail with reference to examples, but the exemplary embodiments of the disclosure are not limited to these examples.

In the following description, unless otherwise specified, “part(s)” and “%” are based on weight.

Unless otherwise specified, synthesis, treatment, preparation and the like are carried out at a room temperature (25° C.±3° C.).

In examples, the coarse toner (or coarse particles) means a toner (or particles) having a particle diameter of 1.75 times or more the volume average particle diameter of the toner (or particles).

### <Preparation of Particle Dispersion>

### [Preparation of Polyester Resin Particle Dispersion (1)]

Polyoxypropylene (2,2)-2,2-bis(4-hydroxyphenyl)propane: 80 mol parts
Ethylene glycol: 10 mol parts
Cyclohexanediol: 10 mol parts
Terephthalic acid: 80 mol parts
Isophthalic acid: 10 mol parts
n-dodecenyl succinic acid: 10 mol parts

The above materials are added in a reaction vessel provided with a stirrer, a thermometer, a condenser, and a nitrogen gas introduction tube, and the inside of the reaction vessel is replaced with dry nitrogen gas. Next, as a catalyst, 0.25 parts of titanium. tetrabutoxide is added to 100 parts of a monomer. A stirring reaction is performed at 170° C. for 3 hours under a nitrogen gas stream, and then the temperature is further raised to 210° C. over 1 hour. Next, the pressure inside the reaction vessel is reduced to 3 kPa, and a stirring reaction under reduced pressure is performed for 13 hours to obtain a polyester resin. The glass transition temperature (Tg) of the obtained polyester resin is 58° C.

200 parts of a polyester resin, 100 parts of methyl ethyl ketone, and 70 parts of isopropyl alcohol are added to a jacketed reaction tank provided with a condenser, a thermometer, a dropping device, and an anchor blade, and the polyester resin is dissolved while keeping at 70° C. in a water circulation type constant temperature bath and stirring and mixing at 100 rpm. Next, a stirring rotation speed is set to 150 rpm, the water circulation type constant temperature bath is set to 66° C., and 10 parts of 10% ammonia aqueous solution is added over 10 minutes. Next, a total of 600 parts of ion exchanged water kept at 66° C. is added dropwise at a rate of 5 parts/min to invert a phase, and an emulsion is obtained. 600 parts of the emulsion and 525 parts of the ion exchanged water are added to an eggplant flask and installed in an evaporator equipped with a vacuum control unit via a trap ball. The mixture is heated in a hot water bath at 60° C. while rotating the eggplant flask, and the pressure is reduced to 7 kPa while paying attention to bumping to remove the solvent. At the time when the amount of solvent collected reaches 825 parts, the pressure is returned to normal pressure, and the eggplant flask is water-cooled to obtain a dispersion. The ion exchanged water is added to adjust the solid content concentration to 20% to obtain a polyester resin particle dispersion (1). The volume average particle diameter of the polyester resin particle dispersion (1) is 180 nm.

### [Preparation of Release Agent Particle Dispersion (W)]

Paraffin wax (Nippon Seiro Co., Ltd., HNP-9, melting temperature: 75° C.): 50 parts
Anionic surfactant (NEOGEN RK, Dai-Ichi Kogyo Seiyaku Co., Ltd.): 5 parts
Ion exchanged water: 200 parts

The materials are mixed, heated to 95° C., and dispersed using a homogenizer (Ultratarax T50 manufactured by IKA). Next, the mixture is dispersed with a pressure discharge type gaulin homogenizer, and water is added to adjust the solid content concentration to 20% to obtain a release agent particle dispersion (W). The volume average particle diameter of the release agent particle dispersion (W) is 190 nm.

### [Preparation of Coloring Agent Particle Dispersion (C)]

Cyan pigment (Pigment Blue 15:3, Dainichiseika Kogyo): 100 parts
Anionic surfactant (manufactured by DKS Co. Ltd., Neogen R): 2 parts
Ion exchanged water: 400 parts

The above materials are mixed and dispersed for 60 minutes by using a high-pressure impact disperser (Ultimaizer HJP30006, manufactured by Sugino Machine Ltd.,) to obtain a coloring agent particle dispersion (C) having a solid content concentration of 20%. The volume average particle diameter of the coloring agent particle dispersion (C) is 160 nm.

### Example 1

### [First Aggregating Step]

Ion exchanged water: 200 parts
Polyester resin particle dispersion (1): 100 parts
Release agent particle dispersion (W): 9 parts
Coloring agent particle dispersion (C): 10 parts
Anionic surfactant (TAYCA Corporation, TaycaPower BN2060): 1 part

The above materials are added in a cylindrical stainless steel vessel and mixed by stirring to obtain a mixed dispersion. A pH is adjusted to 3.0 by adding 3 parts of a 0.3 M aqueous nitric acid solution to the mixed dispersion.

While applying a shearing force to the mixed dispersion with a homogenizer (Ultratarax T50 manufactured by IKA), 50 parts of a 10% aqueous solution of aluminum sulfate is added dropwise as an aggregating agent, and the mixture is stirred for 5 minutes. Next, the mixed dispersion is heated to 45° C. with a mantle heater and kept for 30 minutes to form aggregated particles.

### [Second Aggregating Step]

25 parts of the polyester resin particle dispersion (1) and 10 parts of ion exchanged water are mixed, and the pH thereof is adjusted to 3.0 to obtain a resin particle dispersion for forming a shell layer. A resin particle dispersion for forming a shell layer is added to the dispersion undergone the first aggregating step, and the mixture is kept for 10 minutes to obtain a dispersion containing the second aggregated particles. Next, a 1 M aqueous sodium hydroxide solution is added, and the pH of the dispersion containing the second aggregated particles is adjusted to 8.0.

### [Coalescing Step]

A mixed aqueous solution (1) in which nitric acid and sodium alkylbenzene sulfonate are mixed is prepared. Table 1 shows the ratio A/B of the molar amount of the nitric acid A to the molar amount B of sodium alkylbenzene sulfonate which are contained in the mixed aqueous solution (1), and the total weight of the nitric acid and the sodium alkylbenzene sulfonate.

The dispersion containing the second aggregated particles is heated to 90° C., at a heating rate of 1%/min. 6 parts of the mixed aqueous solution (1) is added 30 minutes after the time when the temperature reaches 90° C. The average circularity of the particles at this time is 0.93. While continuing stirring, the circularity of the particles is measured every 30 minutes and kept until the average circularity reaches 0.98. The time from reaching 90° C. until the average circularity of the particles reached 0.98 is 1 hour.

Then, the dispersion is cooled to a room temperature and a solid content is filtered off The solid content is redistributed in ion exchanged water, filtration is repeated, and cleaning is performed until the electrical conductivity of the filtrate becomes 20 μS/cm or less. Next, the toner particles are obtained by vacuum drying in a vacuum dryer having an internal temperature of 40° C. for 5 hours. The volume average particle diameter of the toner particles is 6.0 μm, and a proportion of toner particles having a particle diameter of 10.5 μm or more (1.75 times or more of the volume average particle diameter) is 0.8% by volume.

### [Addition of External Additive]

100 parts of toner particles and 1.5 parts of hydrophobic silica particles (RY50, Nippon Aerosil Co., Ltd.) are added in a sample mill and mixed at a rotation speed of 10,000 rpm for 30 seconds. Then, the toner is obtained by sieving with a vibrating sieve having a mesh size of 45 μm.

### [Preparation of Carrier]

Ferrite particles (average particle diameter: 50 μm): 100 parts
Polymethylmethacrylate resin (weight average molecular weight 95,000): 1.5 parts
Toluene: 500 parts

The above materials are added in a pressurized kneader, stirred and mixed at room temperature for 15 minutes, then heated to 70° C. while mixing under reduced pressure, and toluene is distilled off and the mixture is cooled. The particles taken out from the pressurized kneader are classified using a 105 μm sieve to obtain carriers.

### [Preparation of Developer]

5 parts of the toner and 95 parts of the carrier are added in a V-type blender and stirred for 20 minutes, and then sieved with a vibrating sieve having a mesh size of 212 μm to obtain a developer.

### Examples 2 to 19, Comparative Examples 1 to 3

In the same manner as in Example 1, however, the preparing conditions of the toner particles are changed to the specifications shown in Table I to obtain toner particles. Then, as in Example 1, an external additive is added to the toner particles and mixed with a carrier to obtain a developer. The glass transition temperature (Tg) of the polyester resin is controlled by a molecular weight of the polyester resin.

### <Performance Evaluation>

### [Dot-Like Color Unevenness Caused by Coarse Toner]

The developer is stored in a developing device of a modified machine of an image forming apparatus ApeosPort-IV 05575 manufactured by Fuji Xerox Co,, Ltd. (a modified machine in which an automatic density control sensor is turned off in environmental changes). Using the image forming, apparatus, 5,000 images having an image density of 1% are continuously printed on A4 paper in an environment of a temperature of 10° C. and a relative humidity of 15%, Subsequently, 1,000 images having an image density of 80% are continuously printed on A4 paper in an environment of a temperature of 30° C. and a relative humidity of 85%. The presence or absence of color spots is visually confirmed in 1,000 images printed with an image density of 80%, and the images are classified according to the following criteria.

A: No color spots are generated.

B: Color spots are generated on 1 or more and 3 or less sheets.

C: Color spots are generated on 4 or 5 sheets.

D: Color spots are generated on 6 or more and 10 or less sheets.

E: Color spots are generated on 11 or more sheets.

### [Transferability]

The developer is stored in the developing device of the modified machine of the image forming apparatus 700 Digital Color Press manufactured by Fuji Xerox Co., Ltd. The developing potential is adjusted so that the toner applied amount on a photosensitive body is 5 g/m², and 1,000 images with an image area proportion of 5% are continuously printed on A4 size plain paper in an environment of a temperature of 10° C. and a relative humidity of 20%. When printing one sheet sequentially, an evaluation machine is stopped immediately after the toner image on the photosensitive body is transferred to an intermediate transfer belt (that is, before cleaning the photosensitive body). The toner remaining on the photosensitive body without being transferred is removed with a mending tape, and a weight thereof is measured. A transfer efficiency is calculated from the toner applied amount and the toner residual amount at the time of development by the following formula (1), and classified according to the following criteria.

Transfer efficiency=(Toner applied amount during development−Toner residual amount)/Toner applied amount during development×100 Equation (1)

A: Transfer efficiency is 98% or more

B: Transfer efficiency is 96% or more and less than 98%

C: Transfer efficiency is 94% or more and less than 96%

D: Transfer efficiency is 90% or more and less than 94%

E: Transfer efficiency is less than 90%

TABLE 1

| | | Coalescing step | | | | | | | | | |
|---|---|---|---|---|---|---|---|---|---|---|---|
| | | | Temper- | | Average | | | | | | |
| | | | ature of | Elapsed | circu- | | | | | Performance | |
| | | Maximum | aggregated | time from | larity of | | | Toner | | evaluation | |
| | | temper- | particle | reaching | aggregated | Mixed aqueous | | particles | | Dot- | |
| | | ature of | dispersion | maximum | particles | solution | | Volume | Proportion | like | |
| | Binder | aggregated | when adding | temperature | when adding | Mixing | Component | average | of coarse | color | Trans- |
| | resin | particle | mixed aqueous | to start of | mixed aqueous | ratio | content | particle | particles | uneven- | fer- |
| | Tg | dispersion | solution | addition | solution | A:B | % by | diameter | % by | ness | ability |
| | ° C. | ° C. | ° C. | Minutes | — | — | weight | μm | volume | — | — |
| Comparative | 58 | 78 | 78 | 0 | 0.85 | 1:1 | 5 | 6.1 | 2.5 | D | C |
| Example 1 | | | | | | | | | | | |
| Comparative | 58 | 78 | 78 | 30 | 0.88 | 1:1 | 5 | 6.0 | 2.2 | D | C |
| Example 2 | | | | | | | | | | | |
| Comparative | 58 | 90 | 78 | — | 0.85 | 1:1 | 5 | 6.1 | 2.8 | D | C |
| Example 3 | | | | | | | | | | | |
| Example 2 | 58 | 90 | 82. | — | 0.90 | 1:1 | 5 | 5.9 | 1.7 | C | B |
| Example 3 | 58 | 90 | 85 | — | 0.91 | 1:1 | 5 | 6.0 | 1.4 | B | B |
| Example 4 | 58 | 90 | 90 | 0 | 0.92 | 1:1 | 5 | 5.9 | 1.2 | B | A |
| Example 1 | 58 | 90 | 90 | 30 | 0.93 | 1:1 | 5 | 6.0 | 0.8 | A | A |
| Example 5 | 58 | 98 | 98 | 30 | 0.95 | 1:1 | 5 | 6.1 | 1.4 | B | B |
| Example 6 | 58 | 100 | 100 | 30 | 0.97 | 1:1 | 5 | 6.2 | 1.8 | C | C |
| Example 7 | 46 | 90 | 90 | 30 | 0.93 | 1:1 | 5 | 6.1 | 0.9 | A | A |
| Example 8 | 46 | 96 | 96 | 30 | 0.95 | 1:1 | 5 | 6.2 | 1.5 | C | B |
| Example 9 | 46 | 98 | 98 | 30 | 0.97 | 1:1 | 5 | 6.3 | 2.1 | D | C |
| Example 10 | 58 | 90 | 90 | 10 | 0.925 | 1:1 | 5 | 5.9 | 0.4 | B | A |
| Example 11 | 58 | 90 | 90 | 60 | 0.94 | 1:1 | 5 | 5.9 | 1.0 | A | B |
| Example 12 | 58 | 90 | 90 | 120 | 0.95 | 1:1 | 5 | 6.1 | 1.2 | B | B |
| Example 13 | 58 | 90 | 90 | 180 | 0.96 | 1:1 | 5 | 6.2 | 1.4 | C | C |
| Example 14 | 58 | 90 | 90 | 30 | 0.93 | 2:1 | 5 | 6.2 | 1.8 | C | A |
| Example 15 | 58 | 90 | 90 | 30 | 0.93 | 1:2 | 5 | 5.9 | 0.4 | A | C |
| Example 16 | 58 | 90 | 90 | 30 | 0.93 | 1:1 | 0.8 | 6.1 | 2.0 | D | B |
| Example 17 | 58 | 90 | 90 | 30 | 0.93 | 1:1 | 1 | 5.9 | 1.8 | C | B |
| Example 18 | 58 | 90 | 90 | 30 | 0.93 | 1:1 | 10 | 6.1 | 1.0 | B | B |
| Example 19 | 58 | 90 | 90 | 30 | 0.93 | 1:1 | 12 | 6.3 | 1.4 | C | D |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A preparing method of an electrostatic charge image developing toner, the method comprising:
aggregating binder resin particles in a dispersion containing the binder resin particles to form aggregated particles; and
coalescing the aggregated particles by heating a dispersion containing the aggregated particles to form toner particles, wherein
the coalescing includes heating the dispersion containing the aggregated particles to 80° C. or higher so that a temperature of the dispersion containing the aggregated particles reaches 80° C., and then adding an acid and a surfactant to the dispersion containing the aggregated particles.

2. The preparing method of an electrostatic charge image developing toner according to claim 1, wherein
in the coalescing, the temperature of the dispersion containing the aggregated particles when adding the acid and the surfactant is 80° C. or higher and (glass transition temperature of the binder resin particles 50° C.) or lower.

3. The preparing method of an electrostatic charge image developing toner according to claim 1, wherein
in the coalescing, adding the acid and the surfactant to the dispersion containing the aggregated particles is started at a time when 10 minutes or more and 3 hours or less passes from a time when the temperature of the dispersion containing the aggregated particles reaches a maximum temperature.

4. The preparing method of an electrostatic charge image developing toner according to claim 2, wherein
in the coalescing, adding the acid and the surfactant to the dispersion containing the aggregated particles is started at a time when 10 minutes or more and 3 hours or less passes from a time when the temperature of the dispersion containing the aggregated particles reaches a maximum temperature.

5. The preparing method of an electrostatic charge image developing toner according to claim 1, wherein
in the coalescing, an average circularity of the aggregated particles when adding the acid and the surfactant is 0.90 or more and 0.97 or less.

6. The preparing method of an electrostatic charge image developing toner according to claim 2, wherein
in the coalescing, an average circularity of the aggregated particles when adding the acid and the surfactant is 0.90 or more and 0.97 or less.

7. The preparing method of an electrostatic charge image developing toner according to claim 3, wherein
in the coalescing, an average circularity of the aggregated particles when adding the acid and the surfactant is 0,90 or more and 0.97 or less. 8, The preparing method of an electrostatic charge image developing toner according to claim 4, wherein
in the coalescing, an average circularity of the aggregated particles when adding the acid and the surfactant is 0.90 or more and 0.97 or less.

9. The preparing method of an electrostatic charge image developing toner according to claim 1, wherein
a ratio A/B of a molar amount A of the acid to a molar amount B of the surfactant to be added to the dispersion containing the aggregated particles is 0.5 or more and 2.0 or less,

10. The preparing method of an electrostatic charge image developing toner according to claim 2, wherein
a ratio A/B of a molar amount A of the acid to a molar amount B of the surfactant to be added to the dispersion containing the aggregated particles is 0.5 or more and 2.0 or less,

11. The preparing method of an electrostatic charge image developing toner according to claim 3, wherein
a ratio A/B of a molar amount A of the acid to a molar amount B of the surfactant to be added to the dispersion containing the aggregated particles is 0.5 or more and 2.0 or less.

12. The preparing method of an electrostatic charge image developing toner according to claim 1, wherein
in the coalescing, adding the acid and the surfactant refers to adding a mixture of the acid and the surfactant.

13. The preparing method of an electrostatic charge image developing toner according to claim 12, wherein
a total weight of the acid and the surfactant in a total weight of the mixture is 1% by weight or more and 10% by weight or less.

14. The preparing method of an electrostatic charge image developing toner according to claim 1, wherein
the acid includes at least one selected from the group consisting of nitric acid, sulfuric acid, hydrochloric acid, and acetic acid.

15. The preparing method of an electrostatic charge image developing toner according to claim 1, wherein
the surfactant includes an anionic surfactant.

16. The preparing method of an electrostatic charge image developing toner according to claim 1, wherein
the dispersion containing the binder resin particles further contains release agent particles, and
in the aggregating, the release agent particles are further aggregated to form the aggregated particles.

17. The preparing method of an electrostatic charge image developing toner according to claim 1, wherein
the dispersion containing the binder resin particles further contains coloring agent particles, and
in the aggregating, the coloring agent particles are further aggregated to form the aggregated particles.

18. The preparing method of an electrostatic charge image developing toner according to claim 1, further comprising:
after the aggregating, second aggregating of further mixing the dispersion containing the aggregated particles and a dispersion containing resin particles to be a shell layer and aggregating the resin particles to be the shell layer on surfaces of the aggregated particles to form second aggregated particles, wherein
in the coalescing, a dispersion containing the second aggregated particles is heated and the second aggregated particles are coalesced to form toner particles, and
the coalescing includes heating the dispersion containing the second aggregated particles to 80° C. or higher so that a temperature of the dispersion containing the second aggregated particles reaches 80° C., and then adding an acid and a surfactant to the dispersion containing the second aggregated particles.

9. An electrostatic charge image developing toner which is prepared by the preparing method of an electrostatic charge image developing toner according to claim 1.

20. An electrostatic charge image developer comprising an electrostatic charge image developing toner which is prepared by the preparing method of an electrostatic charge image developing toner according to claim 1.
